(19) United States
(12) Patent Application Publication
(10) Pub. No.: US 2005/0003147 A1
(43) Pub. Date: Jan. 6, 2005

(54) Laminated board and methods of producing the same

(75) Inventor: Joe Torrey, Vicksburg, MS (US)

Correspondence Address: PATTON BOGGS LLP, 8484 WESTPARK DRIVE, SUITE 900, MCLEAN, VA, 22102, US

(73) Assignee: Anderson-Tully Engineered Wood LLC, Vicksburg, MS (US)

(21) Appl. No.: 10/807,176

(22) Filed: Mar. 24, 2004

Related U.S. Application Data
(60) Provisional application No. 60/456,557, filed on Mar. 24, 2003.

(51) Int. Cl. B32B 3/14

(52) U.S. Cl. 428/114

(57) ABSTRACT

The present invention provides laminated wood boards having improved structural and aesthetic features. The size, number and orientation of the plies provides a board that is resistant to damage and easily finished to produce a visually pleasing result.

### FIELD OF INVENTION

The present invention is in the field of laminated wood boards having improved structural and aesthetic features.

### BACKGROUND OF THE INVENTION

The process of laminating several independent layers of wood together to form a single multilayer board can be used to fabricate laminated boards for many uses. For example, sheet plywood fabricated from multiple layers of softwood, such as southern yellow pine, can be used as wall and roof sheathing in construction of homes.

The production of such plywood involves the lamination of several layers of individual sheets of wood to form a single plywood board. The individual sheets of wood for such an application are typically cut with the grain from large logs, ripped to the desired length, and laminated together with adhesive to form the final product. Through this type of process various grades of finished plywood can be produced. For example, plywood can be fabricated that has knots replaced with clear wood plugs present in an exterior or interior layer.

Alternatively, plywood can be fabricated so that the top layer of laminate is clear, resulting in a final board having an improved appearance. By altering the quality of the internal and external layers it is therefore possible to achieve various grades of strength and appearance.

Hardwood laminated board applications are also conventionally used in construction, and particularly for applications where an attractive appearance is desired. The design of hardwood laminate board applications can involve the same considerations that are involved in the design of plywood and other softwood applications. Additionally, it is desirable to produce hardwood boards that have an appealing finished appearance for use in any construction where such an appearance is desirable.

Conventional laminated boards can be inappropriate for use in some applications, however, because the manner in which the layers are oriented with respect to one another does not allow for an attractive appearance on finished edges of the laminated board or does not provide for the strength needed for many uses. What are needed in the art are methods for fabricating laminated boards that can result in a desirable appearance when edge finished without diminishing strength and dimensional stability, and boards produced by such methods.

### SUMMARY OF THE INVENTION

The present invention includes and provides a method for fabricating strong, dimensionally stable laminated wood boards and shaped articles useful in a variety of applications, including, but not limited to, architectural applications where an attractive appearance is desired. The present invention also includes and provides laminated wood boards made by these methods.

In particular, the present invention relates to the production of hardwood laminated boards that have two or more thin layers aligned bilaterally, thus providing strength and stability. The present invention also provides for the production of hardwood laminated boards having two or more layers aligned unilaterally such that the finished product can be milled or finished along the long edge of the board to produce an improved finished appearance. In specific embodiments, all of the layers of the board are aligned unilaterally, and the tight or loose side of any of the individual boards is disposed in contact with the equivalent sides of the boards on either side.

Because of the size and lay up of the individual layers, the boards and shaped products of the present invention have the advantage of being resistant to cup and lateral movement while providing a long edge that can easily be finished to produce an aesthetically pleasing result.

One embodiment of the present invention includes and provides a wood board, comprising a first layer of wood; a second layer of wood disposed in contact with said first layer of wood; a third layer of wood disposed in contact with said second layer of wood; a fourth layer of wood disposed in contact with said third layer of wood; and, a fifth layer of wood disposed in contact with said fourth layer of wood, wherein said first layer of wood, said second layer of wood, said third layer of wood, said fourth layer of wood and said fifth layer of wood are hardwood and oriented so that grain of said first layer of wood, grain of said second layer of wood, grain of said third layer of wood, grain of said fourth layer of wood and grain of said fifth layer of wood are bilaterally aligned. In an additional embodiment of the invention, wood boards are provided comprising a first layer of wood; a second layer of wood disposed in contact with said first layer of wood; a third layer of wood disposed in contact with said second layer of wood; a fourth layer of wood disposed in contact with said third layer of wood; and, a fifth layer of wood disposed in contact with said fourth layer of wood, wherein said first layer of wood, said second layer of wood, said third layer of wood, said fourth layer of wood and said fifth layer of wood are hardwood and oriented so that grain of said first layer of wood, grain of said second layer of wood, grain of said third layer of wood, grain of said fourth layer of wood and grain of said fifth layer of wood are unilaterally aligned. Additional embodiments would include wood boards made of both unilaterally aligned sections and bilaterally aligned sections, chosen to obtain the best combination of strength and aesthetic appeal when finished.

The present invention includes and provides a wood board comprising a first, second, third, fourth, and fifth layer of wood, wherein said layers of wood are hardwood, laminated together in parallel planes, and oriented so that grain of said five layers of wood are unilaterally aligned. An additional embodiment of the present invention provides for a wood board comprising a first, second, third, fourth, and fifth layer of wood, wherein said layers of wood are hardwood, laminated together in parallel planes, and oriented so that grain of said five layers of wood are bilaterally aligned.

The present invention further provides for a wood board comprising 20 or more layers of wood, wherein said layers of wood are hard wood, laminated together in parallel planes, and oriented so that the grain of the layers of the wood are either bilaterally or unilaterally aligned, or both.

The present invention includes and provides a method of fabricating a wood board, comprising laminating layers of wood together to form said board, wherein said board comprises a first layer of wood; a second layer of wood disposed in contact with said first layer of wood; a third layer of wood disposed in contact with said second layer of wood; a fourth layer of wood disposed in contact with said third layer of wood; and, a fifth layer of wood disposed in contact with said fourth layer of wood, wherein said first layer of wood, said second layer of wood, said third layer of wood, said fourth layer of wood, and said fifth layer of wood are hardwood and oriented so that grain of said first layer of wood, grain of said second layer of wood, grain of said third layer of wood, grain of said fourth layer of wood, and grain of said fifth layer of wood are bilaterally aligned. The methods of the invention also provide for a method of fabricating a wood board, comprising laminating layers of wood together to form said board, wherein said board comprises a first layer of wood; a second layer of wood disposed in contact with said first layer of wood; a third layer of wood disposed in contact with said second layer of wood; a fourth layer of wood disposed in contact with said third layer of wood; and, a fifth layer of wood disposed in contact with said fourth layer of wood, wherein said first layer of wood, said second layer of wood, said third layer of wood, said fourth layer of wood, and said fifth layer of wood are hardwood and oriented so that grain of said first layer of wood, grain of said second layer of wood, grain of said third layer of wood, grain of said fourth layer of wood, and grain of said fifth layer of wood are unilaterally aligned.

In another embodiment of the invention, the wood boards are oriented so that the loose sides of the successive layers are disposed in contact with each other, thus providing greater strength and dimensional stability.

### BRIEF DESCRIPTION OF THE FIGURES

FIG. 1 represents a cross-section of a log being turned on a lathe to produce a layer of wood.

FIG. 2 represents a perspective view of a layer of wood.

FIG. 3 represents a perspective view of a lamination of two layers of wood oriented bilaterally.

FIG. 4a represents a perspective view of a lamination of two layers of wood oriented unilaterally.

FIG. 4b represents a perspective view of a lamination of four layers of wood such that the grain in the wood layers are oriented at an angle denoted by the angle z.

FIG. 5 represents a perspective view of the two layers of wood shown in FIG. 4 in contact.

FIG. 6 represents a schematic view of five layers of wood oriented unilaterally.

### DETAILED DESCRIPTION OF THE INVENTION

The present invention includes and provides a method for fabricating strong, dimensionally stable laminated wood boards and shaped articles that are useful in a variety of applications, including, but not limited to, architectural furniture and cabinetry applications where an attractive appearance is desired. The present invention also includes and provides laminated wood boards made by these methods.

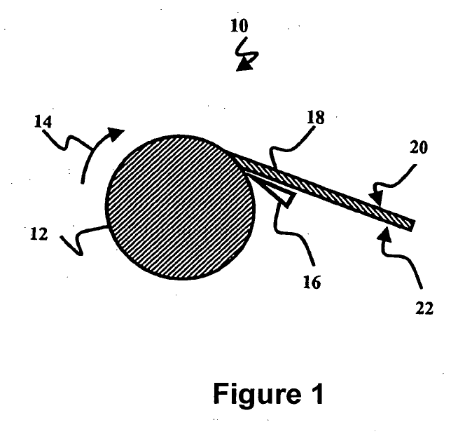

Thin layers of wood produced by any conventional method can be used for the laminated boards of the present invention, where appropriate to any particular embodiment. A preferred method for producing layers of wood is shown in FIG. 1. As shown generally in FIG. 1 at 10, one process of fabricating a board consisting of laminated layers can involve the production of thin sheets of wood. As shown, a log 12, can be rotated on a lathe (not shown) in a clockwise direction 14 from the perspective given in this cross-sectional view. A blade 16 is positioned so as to cause a thin layer 18 of wood to be turned from the log. Because of the manner in which the layer is produced, the layer will have a tight side 20 and a loose side 22. As used herein, a “tight side” is a side of a layer of wood that is more compact and of a greater density of wood than a “loose side”. This result occurs specifically because of the manner in which the board is turned from the log, and would not necessarily be expected to occur for other techniques that can be used to produce individual layers of wood.

Another technique that can be used to produce the individual layers of a laminated board of some embodiments of the present invention involves using a blade to remove a layer from a log in a lengthwise cut with the grain down the length of a log. This technique can produce layers that either do not have a tight side or a loose side as those terms are used herein or have a tight side and a loose side that are very similar wood density.

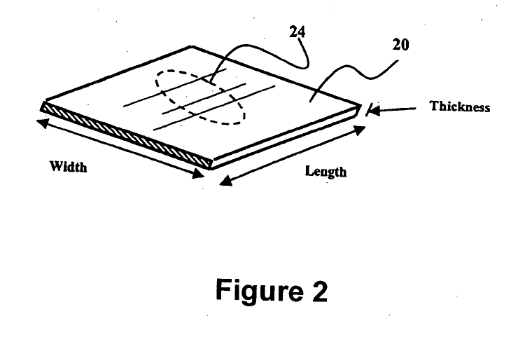

FIG. 2 shows a single layer of wood that has been produced by the method described above and shown in FIG. 1. As shown in FIG. 1, the layer has a tight side 20 facing up, and grain 24 or grain lines running in a single general direction. The layer has a length, a width, and a thickness. Any of these dimensions can be altered to any manufacturable dimension for any particular desired use of the boards of the present invention. A layer can have a thickness of about 0.01 to about 0.5 inches, preferably about 0.05 to about 0.3 inches, or most preferably about 0.1 to about 0.2 inches. The length of board can be any length that the lathe blade can produce, and can be about 25 to about 100 inches, or about 50 to 90 inches, or about 60 to 80 inches. The width can be about 10 to 100 inches, or about 20 to 80 inches, or about 30 to 70 inches, or about 40 to 60 inches. The width of individual layers of a laminated board can be all of the same dimension or can vary according to a particular application.

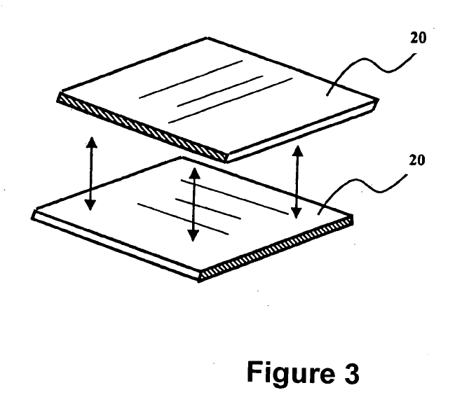

FIG. 3 shows one method for combining two layers to form a laminated board. In this figure, each of the two layers is oriented so that the tight side 20 is facing up. Further, the grain of each board is running in a direction that is oriented 90 degrees from the other layer. This lay up is referred to as a bilateral orientation. As used herein, “grain” refers to the general direction of a layer of wood that corresponds to the direction of vertical growth in the tree from which the wood is derived. The conventional lay up of layers as shown in FIG. 3 may be problematic for use in finished laminated board production, however, because the end grains of the individual layers face in different directions, as shown. If any edge of two layer construction is milled, the individual layers can look very different because of their different grain orientation and the differential response to the milling tool. This results in a finished edge that does not look like finished edge on a solid piece of wood and that can be unappealing aesthetically.

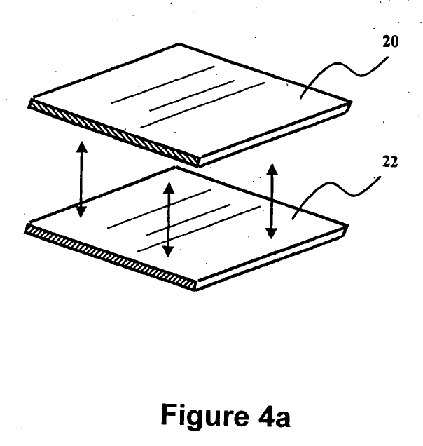

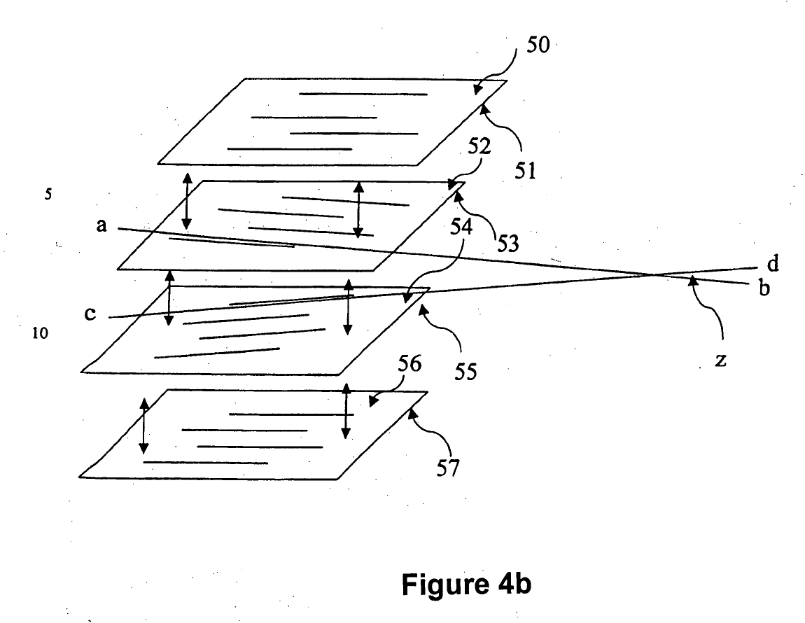

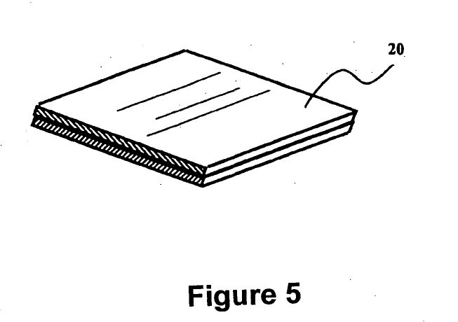

FIG. 4a shows a perspective view of a unilateral lay up of two individual layers of wood in a board of the present invention. As used herein, “unilateral” means aligning the individual layers of wood so that, in the finished board, the grain lines of individual layers of wood run parallel to each other. As shown in the figure, the two layers have been oriented in a unilateral orientation. Further, as shown in FIG. 4a, the layers have been oriented so that the tight side 20 of the top layer is facing up, and the loose side 22 of the bottom layer is facing up. In this orientation, the boards are aligned unilaterally with the loose sides disposed in contact with one another. In a preferred embodiment, the tight side of the top layer of wood in a board is facing to the outside of the board while the loose side of that top layer of wood is facing toward the second, underlying layer of wood. In a further preferred embodiment, the bottom layer of wood (in embodiments with more than two layers) is oriented similarly, so that the tight side of the bottom layer of wood is facing to the outside of the board while the loose side of the bottom layer of wood is facing the layers disposed between the top layer and the bottom layer. FIG. 5 shows the two layers of wood from FIG. 4a disposed in contact with one another.

In another embodiment, shown in FIG. 4b, the layers of laminate are oriented having the grain lines of one or more of the individual layers aligned at an angle to the grain line of one or more other layers at an angle indicated by the angle “z” in FIG. 4b. The angle z is formed by intersection of grain lines ab and cd, which have been extended for the purposes of the drawing. In this embodiment the wood layers are oriented such that no one layer is rotated in the plane of the laminate more than 4° in any direction from any other layer (i.e., the angle z is 4° or less). In other embodiments of the invention, the axes of individual layers may be offset at an angle less than 45°, or more preferably less than about 30°, or more preferably less than about 20°, or more preferably less than about 10°, or more preferably less than about 7°. When the angle z is 0° the boards are in a preferred unilateral orientation. As shown in FIG. 4b, the layers have been oriented so that the tight side 50 of the top layer is facing up, and the tight side 57 of the bottom layer is facing down. The adjacent loose faces which are to be joined internally in the finished laminate are identified as the pair 51 and 52, and the pair 55 and 56. The adjacent loose tight faces which are to be joined internally in the finished laminate are identified as pair 53 and 54.

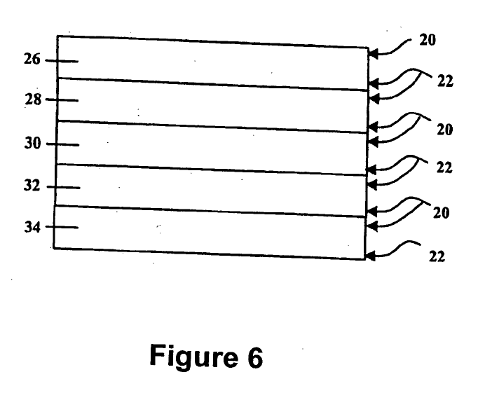

FIG. 6 shows a schematic diagram of a five-layered board of the present invention in cross section. In this embodiment a first layer 26, a second layer 28, a third layer 30, a fourth layer 32, and a fifth layer 34 may oriented bilaterally or unilaterally to each other, with the tight side of the first layer visible from the outside of the board, the loose side of the bottom layer visible from the other side of the board, and the remaining tight and loose sides oriented so as to be disposed in a contact with the corresponding tight or loose side of adjacent layers. Although five layers are shown in this example for the purposes of illustration, the present invention includes boards comprising 2 or more layers, 3 or more layers, 4 or more layers, 5 or more layers, 6 or more layers, 7 or more layers, 8 or more layers, 9 or more layers, 10 or more layers, 11 or more layers, 12 or more layers, 13 or more layers 15 or more layers, 17 or more layers, or 20 or more layers. As discussed above, the individual layers of these boards can be the same thickness or different. In a preferred embodiment, the total thickness of the finished board is about 0.1 inches to about 10 inches, or about 0.25 inches to about 7 inches, or about 0.5 inches to about 5 inches, or about 0.75 inches to about 4 inch, or about 1 inch to about 2 inches. Other preferred range of thicknesses for the finished boards include from about 0.125 inches to about 1.5 inches or about 0.25 inches to about 1.0 inches. In another preferred embodiment, the total thickness of the board is at least about 0.1, 0.25, 0.5, 0.75, 1.0, 1.5, 2.0, or 5.0 inches. Increasing the number of layers in the laminate board, combined with the orientation of all of the tight and loose sides of the individual layers so as to be disposed in contact with the corresponding tight or loose sides of the adjacent layers of wood, gives the unexpected result of increased strength and dimensional stability. In any of the embodiments of the present invention, a subset of the total number of layers can be oriented in a fashion different from the rest of the layers. That is, all of the layers can be oriented unilaterally, or all of the layers except one can be oriented unilaterally, all of the layers except two can be oriented unilaterally, etc. Further, in any embodiment of the present invention, all of the tight and loose sides of the individual layers can be oriented so as to be disposed in contact with the corresponding tight or loose sides of the adjacent layers of wood, or one or more of the layers can be oriented so that a tight side of one layer is in contact with the loose side of an adjacent layer, etc. By altering the orientation of a subset of layers, different results can be achieved. In a preferred embodiment of a board of the present invention, the layers are oriented so that each of the tight and loose sides of the individual layers are in contact with the same side of the adjacent boards, with the exception, of course, of the tight or loose sides of the outside layers that are not in contact with any other tight or loose sides.

As discussed above, wood layers produced by an conventional method of producing thin layers of wood for use in laminated board construction can be used to produce the boards and shaped articles of the present invention including peeled, stripped or cut veneers. Any method known in the art for bonding the individual layers can be used. Methods known in the art include those set forth in to the following patents: Roberti, U.S. Pat. No. 4,012,548; Walser, U.S. Pat. No. 5,234,747; Groger, U.S. Pat. No. 5,415,943; Kajander, U.S. Pat. No. 6,331,339.

A preferred method of preparing the laminates of the invention comprises a series of steps beginning with the preparation of wood layers having a tight and loose surface, applying glue over at least one surface of a first wood layer to be bound to an adjacent layer to form a first glued surface; placing a second layer of wood having a tight and loose surface in contact with said first glued surface, such that said first and said second layers are joined with their grains aligned parallel and such that either the tight surface of said first layer contacts the tight surface of said second layer or such that said lose surface of said first layer contact said lose layer of said second layer. Preferably, both surfaces present at each glue joint will be coated with glue prior to contacting the layers to be joined. The assembled laminate structure may be placed in an unheated or heated press. Typically a force of 200-300 PSI is applied for 15 to 20 minutes. This process forces trapped air out of the glue joints and promotes tacking of the layers together. The laminate structure is then heated to 200° F.-280° C. (100° C.-137° C.) while clamped to a pressure of 200-300 PSI for 6-8 minutes, depending on the glue and wood employed. As an alternative to heating, radio frequency (RF) treatment may be used to heat and cure the adhesive. Employing the laminates of this invention, shaped articles with increased strength and dimensional stability may be prepared by a variety of means known in the art. Laminate sheets may be carved or scrolled to produce a variety of planar shaped articles that may be subsequently joined with one or more similarly prepared carved and scrolled laminate or solid wood articles to prepare objects having complex planer or non-planer shapes. Curved laminate stock may be also be prepared by employing a series of veneer layers and a curved press. In this fashion curved laminate sheets having one or more sections with curved sections can be formed. U.S. Pat. No. 6,319,585, directed to laminate stock for various chair components issued to Coronado, illustrates the formation of complex curved and saddle shaped articles that may be formed from wood laminates. Like their planer counterparts, the curved laminate stock and articles of this invention may be carved, scrolled and joined to laminate or non-laminate articles to form articles having even more complex shapes. Shaped articles which may be produced with the laminates of this invention include, but are not limited to: furniture components, doors, cabinetry, and architectural components.

The finished surfaces of planar or shaped articles may be treated by one or more of painting, staining, embossing, printing or screening, sanding or filling and sanding to remove surface imperfections. In some embodiments painting, staining, embossing, printing or screening, alone or in combination may be employed to enhance the natural wood grain or to apply a wood grain pattern, or produce a panel effect, or other patterns. In other embodiments, the surfaces can be stained and finished with protective coatings such as polyurethanes or lacquers.

Regardless of the shape of the article produced, the laminates of the present invention are unexpectedly stronger than articles produced from solid wood boards. In addition, orientation of the layers with the grain pattern in the same orientation, the finished parts are improved aesthetically, unlike finished parts of solid wood where different cuts are put together, plain sawn, rift cut, etc. Orientation of the layers with the tight and loose sides of the individual layers so as to be disposed in contact with the corresponding tight or loose sides of the adjacent layers of wood unexpectedly improves strength and stability. In addition, because of the capability to grade a very clear face ply, the laminated wood board can supply larger areas of finished footage, unlike solid wood where the amount of prime grade limits the square footage attained, an example would be the manufacturing of doors. A further advantage of the present invention is its surprising resistance to undesired warpage. It also provides uniform expansion and drying patterns similar to solid wood.

Any wood that is suitable for the boards of the present invention can be used with the present invention. In a preferred embodiment, the wood used is a hardwood. In any of the embodiments of the present invention, one or more than one species of wood can be used to form a board. In a preferred embodiment, the layers of a board are derived from a single species of wood. The layers of the wood, including surface veneer layers, can be derived from tree species including, but not limited to, a member of the group consisting of alder, apple, ash, banksia pod, basswood, beech, birch, bloodwood, bubinga, bucote, canary wood, cedar, chakte viga, chenhen, cherry, chestnut, cocobolo, cordia, cypress, ebony, hackberry, hickory, holly, imbula, jatabo, panga panga, pecan, pine, prima vera, poplar, purpleheart wood, redheart, redwood, rosewood, snakewood, spruce, teak, tulip, walnut, willow, wenge, yellowheart, zebra wood, and zircote. The wood veneer which is employed in creating this laminate may be chosen from a wide variety of woods depending on economic considerations, the properties required and the ultimate use contemplated including those previously recited. Preferred woods for the veneer are selected from the group consisting of luan, maple, walnut, ash, poplar, cherry, oak, mahogany, teak, ebony, pine and birch.

One or more layers of the laminate can be treated to enhance the properties of the finished laminate. Inner or outer wood layers of the laminate can be treated enhance the resistance to insect pests (e.g., termites, carpenter ants), molds, fungus, rot, moisture or direct water exposure, UV light damage or fire. In addition, one or more inner or outer layers may be treated to increase the strength or stiffness of the wood layer to be incorporated into the laminate. Examples of the numerous methods of altering the aforementioned properties of wood are recognized in the art and include, but are not limited to, those that follow. Park et al., in U.S. Pat. No. 5,652,065, disclose treating individual layers wood veneer that are to be incorporated into a laminate with thermosetable materials, including polyurea, which increase the strength and stiffness of the individual layers and the formed laminate article. Similarly, Walser et al., U.S. Pat. No. 5,234,747, teaches the use of veneer sheets impregnated with phenolic resins to produce high strength laminates. Greigger et al., U.S. Pat. No. 6,479,574, teach the use of fire retardant, intumescent, curable composition for use in composite materials comprising a combination of polyhydroxy compound, a polyphosphate, a nitrogen-containing compound, and a monomer having polyvinylic unsaturation such as a polyacrylate monomer. Blount, U.S. Pat. No. 6,423,251, teaches fire retardant urea-borate compositions suitable for treating wood products that also provide resistance to pests such as termites. Grantham et al., U.S. Pat. No. 6,235,349, teach methods of treating woods to increase their fire, rot and inset resistant using solutions of a silicate, a rheology modifier, a wetting agent and, optionally, borax and/or a bactericide or fungicide. Depending on the treatment and laminate product to be produced, it may be desirable to treat the logs from which individual laminate layers are cut, the laminate layers, or the finished laminate product to achieve the desired laminate product.

In general, it is contemplated that the surface-to-surface relationship of the adjacent layers of the laminate will be secured by means of a suitable adhesive, which is not shown in the figures. A variety of adhesives may be employed in the preparation of the laminate articles of this invention including but not limited to phenolic and polyisocyanate adhesives, but in each instance the adhesive is preferable applied as a continuous layer covering the entire area over which the laminate layers are in contact. The particular adhesives employed will depend upon the intended end use of the finished product, however, it is generally preferred to employ a water-resistant or waterproof adhesive. Adhesives should also be selected to prevent loss of bonding during storage, handling, and working. It is also preferable to employ adhesives that are stable in a variety of environments over an extended time period. Disbursants may be provided in the adhesive to increase the strength of the resultant articles. Standard 60-65% urea formaldehyde glues, melamine formaldehyde glues, urea melamine formaldehyde glues, phenol formaldehyde glues, resorcin formaldehyde glues, phenol resorcinol formaldehyde glues, or vinyl emulsions with a hardener may be employed in preparing the laminates of this invention. Some suitable adhesives are those sold under the trademarks “GULF L100 Formaldehyde Resin” and “Melamine MB-330”. Another particularly suitable adhesive is that marketed under the designation “CL-8800 Fast Curing Resin Emulsion (Type II Bond)” sold by National Casein (Chicago, Ill.). This product is a water-solvent type adhesive particularly suited to bonding porous and semiporous materials with a viscosity amenable to easy application (about 500-4500 cps at 78° F. (25° C.)).

Adhesives providing increased impact strength to plywood panels and other wood composite/laminate materials may also be employed. For example, Moren et al., U.S. Pat. No. 3,493,417, discloses an adhesive composition comprising a polyol compound, a polymerizable amine formaldehyde resin and curing a catalyst for that resin; Brown et al. U.S. Pat. No. 3,563,788, discloses an aqueous phenol-formaldehyde resole resin solution; Hubbard, U.S. Pat. No. 4,215,173 discloses an alphacyanlacrylate as a bonding resin; Knudson et al., U.S. Pat. No. 4,879,160, discloses an isocyanate type resin adhesive; and Czvikovszky et al., U.S. Pat. No. 4,464,510, discloses an unsaturated polyester resin and a vinyl monomer adhesive.

Adhesives may also be used to enhance the aesthetic appearance of the resulting laminate wood board. For example, the adhesive may be treated with a colored dye in order to blend with the wood grain. Alternatively, an adhesive containing a colored dye may be used to provide contrast with the wood grain.

Expanding glues may be advantageously employed with the wood products of the present invention to provide both an adhesive and to fill any voids present in the product. The use of expanding glues in the preparation of composite wood structures is known. For example, Elbez et al., U.S. Pat. No. 4,376,003, discloses the use of expanding polymer glues comprising a polymer glue containing a hardener and one volatile pore-generating agent. Voids may be present in the laminate structure either by design or as a result of imperfections in the wood employed to prepare the laminate.

Thermoplastic adhesives may also be employed in the preparation of the laminate articles of this invention. Various thermoplastic resins, known in the art such as polyesters, polyolefins, have been used as adhesives for wood laminates as in Mitsumata, U.S. Pat. No. 4,865,912 and Dawes, U.S. Pat. No. 3,817,837. Sublett discloses modified polyester blends which optionally contain polyethylene terephthalate in U.S. Pat. No. 4,062,907. A preferred thermoplastic adhesive is disclosed by Groger et al.,U.S. Pat. No. 5,415,943, which preferably contains polyethylene terephthalate, about 80-20% by weight of thermoplastic polyolefin, preferably polyethylene, and about 0-10% by weight of additives. Employing thermoplastic adhesives such as those disclosed by Groger can result in panels and laminate articles having improved bonding and improved impact resistance.

In methods of employing thermoplastic adhesives, such as those described by Groger et al. in U.S. Pat. No. 5,415,943, the composite blend is added to the surface of individual wood layers by film extrusion or is transferred by pressing or molding. When the adhesive mixture is applied as a film, the film generally has a thickness ranging from about 0.002 to about 0.125 inches and preferably from about 0.015 to about 0.010 inches. After the assembly of the laminate article with interposed layers of thermoplastic adhesive, the article is heated by any method known in the art, including but not limited to direct contact with heated surfaces, infrared lights, or microwaves (RF), and the article is subject to pressure and permitted to cool below the melt temperature of the adhesive. The wood laminate article once formed, may be subjected to post fabrication treatments, such as heating, to achieve additional increased bonding strength and impact resistance. As previously discussed, the finished surfaces may be treated by one or more of painting, staining, embossing, printing or screening, sanding or filling and sanding to remove surface imperfections. In some embodiments painting, staining, embossing, printing, or screening, alone or in combination may be employed to enhance the natural wood grain or to apply a wood grain pattern, or produce a panel effect, or other patterns.

It is expected the end manufacturer will glue plies together for thicker material, machine proper profiles, and storm and/or seal products, preferably with spray or roll on material. It should be clear that the type of end product will influence the choice of parameters described above.

Another useful embodiment of the invention contemplates adding non-wood and non-veneer components between the wood veneer sheets. Incorporation of metals such as aluminum, steel, or lead can lead to products with desirable qualities. Mylar, Kevlar, or fabric can also be added between the sheets to enhance the qualities of the final wood product. If these non-wood components are thin, they can be the same size as the wood sheet without affecting the visual qualities of the finished product. Alternatively, the non-wood materials can be sized smaller than the edges of the wood veneer and applied so that the wood edge likely to be viewed will not show the non-wood materials. Non-veneer components such as masonite, chip board, or other wood product other than a veneer can also be added as part of the manufactured board.

The following example is for illustrative purposes and should not be considered as a limitation of disclosed invention.

### EXAMPLE 1

Number 2 or better logs of 14-18 feet were steamed overnight and positioned in the veneer lathe. The veneer lathe was equipped with a water sprayer to constantly wet the veneer as it was stripped off of the log. The veneer thickness was set at 0.107 inches with a spur length of 72.5 inches and a clip width of 55 inches. At this point in the process, unilateral veneer plies are in effect. The stripped veneer is then dried flat, resulting in a thickness of 0.099 inches and a moisture content of 5-7%. The dried material is graded as Face Veneer (sound and better, dime open and better) or Core and Back Veneer (quarter open and better). The composition contemplates random core grade material. The veneer plies are interleaved such that the Face veneer is positioned tight side up and all other plies are positioned so that the loose side opposes the tight side. This helps to equalize the panel moisture and sets up the lay-up procedure. The interleaved material is then equalized for seven days. After equilibration, the veneers are pressed into panels using a hot press temperature of 270° F., a prepress cycle of 15 minutes followed by a hot press cycle of 15 minutes where the hydraulic press pressure is 175 PSI. UF Dynea is one of the common interior or exterior resins used to create the panels. Samples can be pulled at the pressing operation for bond checks. After approximately five days or more of panel equilibration, the panels can be sanded and cut to size. Sanding can be accomplished by bottom sanding with grits of 40, 60 and 80 and top sanding with grits of 60, 80 and 120. These boards are then ripped 12 inches wide and 70 inches long. They can then be used in such items as doors, stair treads, handrails, etc.

One of skill in the art will immediately recognize other uses for this material. Any references cited above are specifically incorporated by reference in their entirety.

1. A wood board, comprising:
a first layer of wood;
a second layer of wood disposed in contact with said first layer of wood;
a third layer of wood disposed in contact with said second layer of wood;
a fourth layer ofwood disposed in contact with said third layer of wood; and
a fifth layer of wood disposed in contact with said fourth layer of wood, wherein said first layer of wood, said second layer of wood, said third layer of wood, said fourth layer of wood, and said fifth layer of wood are hardwood and oriented so that grain of said first layer of wood, grain of said second layer of wood, grain of said third layer of wood, grain of said fourth layer of wood, and grain of said fifth layer of wood are bilaterally aligned.

2. A wood board, comprising:
a first layer of wood;
a second layer of wood disposed in contact with said first layer of wood;
a third layer of wood disposed in contact with said second layer of wood;
a fourth layer of wood disposed in contact with said third layer of wood; and
a fifth layer of wood disposed in contact with said fourth layer of wood, wherein said first layer of wood, said second layer of wood, said third layer of wood, said fourth layer of wood, and said fifth layer of wood are hardwood and oriented so that grain of said first layer of wood, grain of said second layer of wood, grain of said third layer of wood, grain of said fourth layer of wood, and grain of said fifth layer of wood are unilaterally aligned.

3. The board of claim 1, further comprising a sixth layer of wood disposed in contact with said fifth layer, a seventh layer of wood disposed in contact with said sixth layer, an eighth layer of wood disposed in contact with said seventh layer, a ninth layer of wood disposed in contact with said eighth layer, and a tenth layer wood disposed in contact with said ninth layer.

4. The board of claim 1, further comprising an eleventh layer of wood disposed in contact with said tenth layer, a twelfth layer of wood disposed in contact with said eleventh layer, and a thirteenth layer of wood disposed in contact with said twelfth layer.

5. The board of claim 4, wherein each of said sixth through thirteenth layers are hardwood and oriented so that grain of all of said layers are bilaterally aligned.

6. The board of claim 2, further comprising a sixth layer of wood disposed in contact with said fifth layer, a seventh layer of wood disposed in contact with said sixth layer, an eighth layer of wood disposed in contact with said seventh layer, a ninth layer of wood disposed in contact with said eighth layer, and a tenth layer wood disposed in contact with said ninth layer.

7. The board of claim 2, further comprising an eleventh layer of wood disposed in contact with said tenth layer, a twelfth layer of wood disposed in contact with said eleventh layer, and a thirteenth layer of wood disposed in contact with said twelfth layer.

8. The board of claim 7, wherein each of said sixth through thirteenth layers are hardwood and oriented so that grain of all of said layers are unilaterally aligned.

9. The board of claim 5, wherein a loose side of said first layer of wood is disposed in contact with a loose side of said second layer of wood, a loose side of said third layer of wood is disposed in contact with a loose side of said fourth layer of wood, a loose side of said fifth layer of wood is disposed in contact with a loose side of said sixth layer of wood, a loose side of said seventh layer of wood is disposed in contact with a loose side of said eighth layer of wood, a loose side of said ninth layer of wood is disposed in contact with a loose side of said tenth layer of wood, a loose side of said eleventh layer of wood is disposed in contact with a loose side of said twelfth layer of wood, and a tight side of said fifth twelfth layer of wood is disposed in contact with a tight side of said thirteenth layer of wood.

10. The board of claim 8, wherein a loose side of said first layer of wood is disposed in contact with a loose side of said second layer of wood, a loose side of said third layer of wood is disposed in contact with a loose side of said fourth layer of wood, a loose side of said fifth layer of wood is disposed in contact with a loose side of said sixth layer of wood, a loose side of said seventh layer of wood is disposed in contact with a loose side of said eighth layer of wood, a loose side of said ninth layer of wood is disposed in contact with a loose side of said tenth layer of wood, a loose side of said eleventh layer of wood is disposed in contact with a loose side of said twelfth layer of wood, and a tight side of said fifth twelfth layer of wood is disposed in contact with a tight side of said thirteenth layer of wood.

11. The board of claim 1, wherein a loose side of said first layer of wood is disposed in contact with a loose side of said second layer of wood, a loose side of said third layer of wood is disposed in contact with a loose side of said fourth layer of wood, and a tight side of said fourth layer of wood is disposed in contact with a tight side of said fifth layer of wood.

12. The board of claim 1, wherein said board is about 0.25 inches to about 2.5 inches in thickness, wherein thickness is measured perpendicularly through said layers.

13. The board of claim 12, wherein said board is about 0.5 to about 2.0 inches in thickness.

14. The board of claim 13, wherein said board is about 1.0 to 1.5 inches in thickness.

15. The board of claim 1, wherein non-wood components are interspersed between the wood veneer sheets.

16. The board of claim 15, wherein the non-wood components are selects from the group consisting of aluminum, steel and lead.

17. A wood board comprising a first, second, third, fourth and fifth layer of wood, wherein said layers of wood are hardwood, laminated together in parallel planes, and oriented so that grain of said five layers of wood are bilaterally aligned.

18. A wood board comprising a first, second, third, fourth and fifth layer of wood, wherein said layers of wood are hardwood, laminated together in parallel planes, and oriented so that grain of said five layers of wood are unilaterally aligned.

19. The board of claim 17, further comprising a sixth, seventh, eighth, ninth, and tenth layer of wood, wherein said ten layers of wood are hardwood, laminated together in parallel planes, and oriented so that grain of said ten layers of wood are bilaterally aligned.

20. The board of claim 18, further comprising a sixth, seventh, eighth, ninth, and tenth layer of wood, wherein said ten layers of wood are hardwood, laminated together in parallel planes, and oriented so that grain of said ten layers of wood are unilaterally aligned.

21. The board of claim 17, further comprising an eleventh, twelfth, and thirteenth layer, wherein said thirteenth layers of wood are hardwood, laminated together in parallel planes, and oriented so that grain of said thirteenth layers of wood are bilaterally aligned.

22. The board claim 18, further comprising an eleventh, twelfth, and thirteenth layer, wherein said thirteenth layers of wood are hardwood, laminated together in parallel planes, and oriented so that grain of said thirteenth layers of wood are unilaterally aligned.

23. The board of claim 21, wherein a loose side of said first layer of wood is disposed in contact with a loose side of said second layer of wood, a loose side of said third layer of wood is disposed in contact with a loose side of said fourth layer of wood, a loose side of said fifth layer of wood is disposed in contact with a loose side of said sixth layer of wood, a loose side of said seventh layer of wood is disposed in contact with a loose side of said eighth layer of wood, a loose side of said ninth layer of wood is disposed in contact with a loose side of said tenth layer of wood, a loose side of said eleventh layer of wood is disposed in contact with a loose side of said twelfth layer of wood, and a tight side of said fifth twelfth layer of wood is disposed in contact with a tight side of said thirteenth layer of wood.

24. The board of claim 22, wherein a loose side of said first layer of wood is disposed in contact with a loose side of said second layer of wood, a loose side of said third layer of wood is disposed in contact with a loose side of said fourth layer of wood, a loose side of said fifth layer of wood is disposed in contact with a loose side of said sixth layer of wood, a loose side of said seventh layer of wood is disposed in contact with a loose side of said eighth layer of wood, a loose side of said ninth layer of wood is disposed in contact with a loose side of said tenth layer of wood, a loose side of said eleventh layer of wood is disposed in contact with a loose side of said twelfth layer of wood, and a tight side of said fifth twelfth layer of wood is disposed in contact with a tight side of said thirteenth layer of wood.

25. The board of claim 17, wherein a loose side of said first layer of wood is disposed in contact with a loose side of said second layer of wood, a loose side of said third layer of wood is disposed in contact with a loose side of said fourth layer of wood, and a tight side of said fourth layer of wood is disposed in contact with a tight side of said fifth layer of wood.

26. The board of claim 17, wherein said board is about 0.25 inches to about 2.5 inches in thickness, wherein thickness is measured perpendicularly through said layers.

27. The board claim 26, wherein said board is about 0.5 to about 2.0 inches in thickness.

28. The board of claim 27, wherein said board is about 1.0 to 1.5 inches in thickness.

29. The board of claim 17, wherein non-wood veneer components are interspersed between the wood veneer sheets.

30. The board of claim 29, wherein the non-wood veneer components are selected from the group consisting of aluminum, steel and lead.

31. A method of fabricating a wood board, comprising:
laminating layers of wood together to form said board, wherein said board comprises a first layer of wood;
a second layer of wood disposed in contact with said first layer of wood;
a third layer of wood disposed in contact with said second layer of wood; and
a fourth layer of wood disposed in contact with said third layer of wood; and
a fifth layer of wood disposed in contact with said fourth layer of wood, wherein said first layer of wood, said second layer of wood, said third layer of wood, said fourth layer of wood, and said fifth layer of wood are hardwood and oriented so that grain of said first layer of wood, grain of said second layer of wood, grain of said third layer of wood, grain of said fourth layer of wood, and grain of said fifth layer of wood are bilaterally aligned.

32. A method of fabricating a wood board, comprising:
laminating layers of wood together to form said board, wherein said board comprises a first layer of wood;
a second layer of wood disposed in contact with said first layer of wood;
a third layer of wood disposed in contact with said second layer of wood; and
a fourth layer of wood disposed in contact with said third layer of wood; and
a fifth layer of wood disposed in contact with said fourth layer of wood, wherein said first layer of wood, said second layer of wood, said third layer of wood, said fourth layer of wood, and said fifth layer of wood are hardwood and oriented so that grain of said first layer of wood, grain of said second layer of wood, grain of said third layer of wood, grain of said fourth layer of wood, and grain of said fifth layer of wood are unilaterally aligned.

33. The method of claim 31, wherein said laminating is performed using an adhesive.

34. The method of claim 33, wherein the adhesive contains a dye.

35. The method of claim 33, wherein the adhesive is an expanding glue.

36. The method of claim 33, wherein the adhesive is a thermoplastic adhesive.

37. The method of claim 33, wherein the adhesive is applied through spraying.

38. The method of claim 33, wherein the adhesive is applied through rolling.

39. The method of claim 33, wherein the adhesive is heat cured.

40. The method of claim 33, wherein the adhesive is radio frequency cured.

41. The method of claim 31, wherein non-wood veneer components are interspersed between the wood veneer sheets.

42. The method of claim 41, wherein the non-wood veneer components are selected from the group consisting of aluminum, steel and lead.

43. A laminated wood board, comprising:
a first layer of wood; and
a second layer of wood disposed in contact with said first layer of wood, wherein said first layer of wood and said second layer of wood are hardwood and oriented so that grain of said first layer of wood and grain of said second layer of wood are bilaterally aligned.

44. A laminated wood board, comprising:
a first layer of wood; and
a second layer of wood disposed in contact with said first layer of wood, wherein said first layer of wood and said second layer of wood are hardwood and oriented so that grain of said first layer of wood and grain of said second layer of wood are unilaterally aligned.
